(19) United States
(12) Patent Application Publication
(10) Pub. No.: US 2017/0152141 A1
(43) Pub. Date: Jun. 1, 2017

(54) METHOD FOR PREPARING HETEROGENEOUS METAL-FREE FENTON CATALYST AND APPLICATION

(71) Applicant: INSTITUTE OF PROCESS ENGINEERING, CHINESE ACADEMY OF SCIENCES, Beijing (CN)

(72) Inventors: He ZHAO, Beijing (CN); Hongbin CAO, Beijing (CN); Di ZHANG, Beijing (CN)

(73) Assignee: Institute of Process Engineering Chinese Academy of Sciences

(21) Appl. No.: 15/362,213

(22) Filed: Nov. 28, 2016

(30) Foreign Application Priority Data
Nov. 27, 2015 (CN) 201510849361.8

(51) Int. Cl. C01B 13/14; B01J 21/18; B01J 37/34; B01J 37/04; B01J 37/02; B01J 31/02; B01J 37/24

(52) U.S. Cl. CPC C01B 13/14; B01J 31/0232; B01J 31/0208; B01J 21/18; B01J 21/185; B01J 37/24; B01J 37/04; B01J 37/0219; B01J 37/343

(57) ABSTRACT

The present invention provides a heterogeneous metal-free Fenton catalyst, a method for preparing the same and use thereof. The catalyst is a carbon-based material surface-bonded with halogenated quinones, wherein the carbon-based material has synergistic action with halogenated quinones. The catalyst is prepared by grafting halogenated quinones onto the carbon-based material, or feeding chlorine during the carbonation process of the carbon-based material for oxidization. The production of hydroxyl radicals by using the catalyst has a low cost and a safe, simple and convenient process. The conditions for producing hydroxyl radicals are mild, without any secondary pollution. Moreover, the radical production has a high, continuous and stable yield, and the hydroxyl radicals can be effectively produced by using no chemicals which are harmful to human bodies, without any side product and any additional substances which are difficult to separate. The catalyst has a great application value in the fields of organic pollutant degradation.

### TECHNICAL FIELD

The present invention belongs to the technical field of catalytic nanomaterials, relates to a heterogeneous metal-free Fenton catalyst, a method for preparing the same and use thereof, especially to a method for producing hydroxyl radicals by using the heterogeneous metal-free Fenton catalyst.

### BACKGROUND ART

Hydroxyl radicals are active oxygen groups having a very high reactivity. They have a strong oxidizing ability, can react with proteins, DNA, lipids and the like, and have a high reaction rate, no selectivity and produce no secondary pollution when reacting with organics. Thus the production of hydroxyl radicals is a key research field in the degradation of poisonous and harmful pollutants in the environmental field. The currently developed methods for producing hydroxyl radicals (.OH) mainly include Fenton reaction, Haber-Weiss reaction, ozone and ultraviolet radiation, corona discharge, plasma discharge and the like.

The Fenton reaction is the most common method for producing hydroxyl radicals, and the mechanism thereof involves producing .OH by catalyzing H₂O₂ with transition metal ions, such as Fe, Cu and the like. In order to be convenient for separation, transition metals or metal oxides are generally loaded to the surfaces of the support, to prepare Fenton heterogeneous catalyst. For example, CN 102671661A discloses a method for producing hydroxyl radicals by loading nano-ferroferric oxide catalyst in multiwalled carbon nanotubes, wherein Fe₃O₄ nanoparticles have a high crystallinity, controllable particle size and a narrow particle size distribution. However, such method has to use metal ions such as iron, copper and the like, resulting in a high catalyst cost and a complex preparation process, and certain problems exist in treatment cost, time, efficiency and the like. The document (Interaction of adsorption and catalytic reactions in water decontamination processes Part I. Oxidation of organic contaminants with hydrogen peroxide catalyzed by activated carbon. Appl Catal B-Environ 58 (2005): 9-18) reports decomposing and producing hydroxyl radicals by applying activated carbon to H₂O₂, which proves that .OH is the main reactive group of the activated carbon/H₂O₂ system. However, the efficiency thereof is not high as compared with the Fenton reaction. The document (Molecular mechanism for metal-independent production of hydroxyl radicals by hydrogen peroxide and halogenated quinones. PNAS 104 (2007): 17575-17578) finds that hydroxyl radicals can be produced by tetrachlorobenquinone, a metabolite of chlorophenol, with addition of H₂O₂ without depending on the metal ion route. Moreover, chloroquinones are dehalogenated and detoxicated at the same time. This method has a low reaction cost and can achieve the degradation of pollutants simultaneously. It is a more ideal novel method for producing radicals. However, residue tetrachlorobenquinone in aqueous solution has a certain risk.

On the basis of the current methods for producing hydroxyl radicals, it is an important technical problem which currently needs to be addressed urgently to seek a method for preparing hydroxyl radicals with low cost, high efficiency and environmental friendly.

### DISCLOSURE OF THE INVENTION

The object of the present invention provides a heterogeneous metal-free Fenton catalyst, a method for preparing the same and use thereof. The carbon-based material has synergistic action with halogenated quinones in the catalyst. The production of hydroxyl radicals by using the catalyst has a low cost and a safe, simple and convenient process. The conditions for producing hydroxyl radicals are mild, without any secondary pollution. Moreover, the radical production has a high, continuous and stable yield, and the hydroxyl radicals can be effectively produced by using no chemicals which are harmful to human bodies, without any side product and any additional substances which are difficult to separate. The catalyst has a great application value in the fields of organic pollutant degradation.

In order to achieve the object, the present invention employs the following technical solution.

One object of the present invention is to provide a heterogeneous metal-free Fenton catalyst, wherein the catalyst is a carbon-based material surface-bonded with halogenated quinones.

The heterogeneous metal-free Fenton catalyst of the present invention is a carbon-based material modified with halogenated quinones. The surface bonding action between halogenated quinones and carbon-based material is mainly the π-π bonding.

The theoretical basis of producing hydroxyl radicals with the heterogeneous metal-free Fenton catalyst is the synergistic effect between the carbon-based material and halogenated quinones. Due to the quinone structures formed on the surfaces thereof by modifying the functional groups on the surface of the carbon-based material and the peroxidase-like properties, the carbon-based material per se will have nucleophilic substitution with H₂O₂ to promote its decomposition, so as to directly produce hydroxyl radicals without dependence on transition metal ions. There comprise double bonds inside the carbon skeleton of the carbon-based material, and the material per se comprises surface oxygen-containing groups and surface defects. By means of strong oxidation, hydroxyl radicals cut and oxidize the carbon material into a structure having a smaller size, to further increase the peroxidase-like activity, promote the electron transfer and re-promote the production of radicals.

The halogenated quinones and the carbon-based material have a mass ratio of from 0.1 to 30, e.g. 0.5, 1, 25, 10, 12, 15, 18, 20, 22, 25 and 28, preferably from 1 to 10.

The carbon-based material is any one selected from the group consisting of graphite oxide, graphene, carbon nanotube, activated carbon, carbon fiber, carbon black and high-temperature carbonized natural organics, or a combination of at least two selected therefrom. The typical but non-limiting combinations are selected from the group consisting of graphite oxide and graphene, carbon nanotube, activated carbon and carbon fiber, carbon black and high-temperature carbonized natural organics, graphene, carbon black and high-temperature carbonized natural organics, graphite oxide, graphene, carbon nanotube, activated carbon, carbon fiber, carbon black and high-temperature carbonized natural organics, etc.

The high-temperature carbonized natural organics comprise forestry and agricultural residues, e.g. straw, bark, rice husk, edible mushroom matrix and the like, animal dung, egg shell and membranes, arthropod shell, etc., carbonized at 200-1000° C. The carbonized natural organics have a high carbon content and properties close to carbon materials.

The halogenated quinones are any one selected from the group consisting of monochloroquinone, dichlorobenzoquinone, trichlorobenzoquinone, tetrachlorobenzoquinone, monobromoquinone, dibromobenzoquinone, tribromobenzoquinone, tetrabromobenzoquinone, tetrafluorobenzoquinone, or a combination of at least two selected therefrom. The typical but non-limiting combinations are selected from the group consisting of monochloroquinone and dichlorobenzoquinone, trichlorobenzoquinone, tetrachlorobenzoquinone and monobromoquinone, dibromobenzoquinone, tribromobenzoquinone, tetrabromobenzoquinone and tetrafluorobenzoquinone, dichlorobenzoquinone, trichlorobenzoquinone, tetrachlorobenzoquinone and monobromoquinone, monochloroquinone, dichlorobenzoquinone, trichlorobenzoquinone, tetrachlorobenzoquinone, monobromoquinone, dibromobenzoquinone, tribromobenzoquinone, tetrabromobenzoquinone and tetrafluorobenzoquinone and so on.

The second object of the present invention is to provide a method for preparing the heterogeneous metal-free Fenton catalyst, comprising: mixing halogenated quinone solution with carbon-based material dispersion, surface-modifying the carbon-based material by halogenated quinone grafting method, to obtain a carbon-based material surface-bonded with halogenated quinones, or modifying the carbon-based material by chlorine oxidation method to obtain a carbon-based material surface-bonded with halogenated quinones.

The carbon-based material is a material in which the carbon element is used as the matrix, and should have a great specific surface area, a better electric and heat-conducting property and chemical stability. The carbon-based material is any one selected from the group consisting of graphite oxide, graphene, carbon nanotube, activated carbon, carbon fiber, carbon black and high-temperature carbonized natural organics, or a combination of at least two selected therefrom. The typical but non-limiting combinations are selected from the group consisting of graphite oxide and graphene, carbon nanotube, activated carbon and carbon fiber, carbon black and high-temperature carbonized natural organics, graphene, carbon black and high-temperature carbonized natural organics, graphite oxide, graphene, carbon nanotube, activated carbon, carbon fiber, carbon black and high-temperature carbonized natural organics, etc.

The carbon-based material in the carbon-based material dispersion has a concentration of from 0.001 to 10 mg/mL, e.g. 0.005 mg/mL, 0.01 mg/mL, 0.02 mg/mL, 0.05 mg/mL, 0.1 mg/mL, 0.5 mg/mL, 0.8 mg/mL, 1.0 mg/mL, 2 mg/mL, 3 mg/mL, 4 mg/mL, 5 mg/mL, 7 mg/mL or 9 mg/mL, preferably from 1 to 5 mg/mL.

The carbon-based material dispersion is prepared by dispersing the carbon-based material into a solvent.

The solvent is water.

The dispersion is ultrasonic dispersion.

The ultrasonic power ranges from 50 to 200 W, e.g. 60 W, 70 W, 100 W, 120 W, 150 W or 180 W, preferably from 50 to 80 W.

The ultrasonic lasts for from 0.5 to 24 h, e.g. 0.8 h, 1 h, 2 h, 3 h, 5 h, 10 h, 12 h, 15 h, 20 h or 22 h, preferably from 1 to 5 h.

The halogenated quinones in the halogenated quinone solution are quinone structures containing halogen substituents on the benzene ring, commonly selected from the group consisting of chlorinated quinone and brominated quinone, e.g. monochloroquinone, dichlorobenzoquinone, trichlorobenzoquinone, tetrachlorobenzoquinone, monobromoquinone, dibromobenzoquinone, tribromobenzoquinone, tetrabromobenzoquinone, tetrafluorobenzo quinone, or a combination of at least two selected therefrom. The typical but non-limiting combinations are selected from the group consisting of monochloroquinone and dichlorobenzoquinone, trichlorobenzoquinone, tetrachlorobenzoquinone and monobromoquinone, dibromobenzoquinone, tribromobenzoquinone, tetrabromobenzoquinone and tetrafluorobenzoquinone, dichlorobenzoquinone, trichlorobenzoquinone, tetrachlorobenzoquinone and monobromoquinone, monochloroquinone, dichlorobenzoquinone, trichlorobenzoquinone, tetrachlorobenzoquinone, monobromoquinone, dibromobenzoquinone, tribromobenzoquinone, tetrabromobenzoquinone and tetrafluorobenzoquinone and so on.

The halogenated quinone solution and the carbon-based material dispersion have a mass concentration (mg/mL) ratio of from 0.1 to 30, e.g. 0.5, 1, 25, 10, 12, 15, 18, 20, 22, 25 or 28, preferably from 1 to 10.

The halogenated quinone solution is added dropwise into the carbon-based material dispersion.

The halogenated quinone grafting is any one selected from the group consisting of ultrasonic grafting, water-bath stirring adsorption grafting or heating reflux grafting, or a combination of at least two selected therefrom.

The ultrasonic grafting lasts for from 0.5 to 48 h, e.g. 1 h, 2 h, 5 h, 10 h, 12 h, 15 h, 20 h, 22 h, 25 h, 28 h, 30 h, 35 h, 40 h or 45 h, preferably from 1 to 10 h.

The ultrasonic power ranges from 50 to 200 W, e.g. 60 W, 70 W, 80 W, 90 W, 100 W, 120 W, 150 W or 180 W, preferably from 50 to 80 W.

The water-bath stirring adsorption grafting lasts for from 2 to 48 h, e.g. 3 h, 5 h, 8 h, 10 h, 15 h, 20 h, 25 h, 30 h, 35 h, 40 h or 45 h, preferably from 3 to 24 h.

The water-bath stirring adsorption grafting is carried out at a temperature of from 25 to 50° C., e.g.

30° C., 32° C., 35° C., 38° C., 40° C., 42° C., 45° C. or 48° C., preferably from 25 to 30° C.

The heating reflux grafting lasts for from 2 to 24 h, e.g. 3 h, 5 h, 8 h, 10 h, 12 h, 15 h, 20 h or 22 h, preferably from 5 to 10 h.

The heating reflux grafting is carried out at a temperature of from 50 to 200° C., e.g. 60° C., 70° C., 80° C., 90° C., 100° C., 120° C., 150° C., 160° C., 180° C. or 190° C., preferably from 70 to 100° C.

The chlorine oxidation method comprises: feeding chlorine during the carbonization of the carbon-based material for oxidization.

The carbon-based material and chlorine have a mass concentration ratio of from 0.1 to 50, e.g. 0.5, 1, 2, 5, 10, 15, 20, 25, 30, 35, 40, 45 or 48, preferably from 1 to 20. The mass concentration is a mass concentration of the carbon-based material and chlorine relative to the reactor volume.

The chlorine has a flow of from 50 to 300 mL/h, e.g. 60 mL/h, 80 mL/h, 100 mL/h, 120 mL/h, 150 mL/h, 180 mL/h, 200 mL/h, 220 mL/h, 250 mL/h or 280 mL/h, preferably from 100 to 200 mL/h.

The carbonization temperature ranges from 200 to 1000° C., e.g. 300° C., 400° C., 500° C., 600° C., 800° C. or 900° C., preferably from 300 to 500° C.

The carbonization has a temperature-rising rate of from 1 to 20° C./min, e.g. 2° C./min, 3° C./min, 5° C./min, 8° C./min, 10° C./min, 12° C./min, 15° C./min or 18° C./min, preferably from 5 to 15° C./min.

As a preferred technical solution, the method for preparing the heterogeneous metal-free Fenton catalyst comprises the following steps of: ultrasonic-dispersing the carbon-based material in a solvent, the ultrasonic power ranges from 50 to 200 W; the ultrasonic lasts for from 0.5 to 24 h, to obtain a carbon-based material dispersion having a concentration of from 0.001 to 10 mg/mL; mixing halogenated quinone solution with the carbon-based material dispersion, wherein the halogenated quinone solution and the carbon-based material dispersion have a mass concentration ratio of from 0.1 to 30, to obtain a carbon-based material surface-bonded with halogenated quinones by halogenated quinone grafting method; or

feeding chlorine during the carbonization of the carbon-based material for oxidization to prepare a carbon-based material surface-bonded with halogenated quinones, wherein the carbon-based material and chlorine have a mass concentration ratio of from 0.1 to 50; the chlorine has a flow of from 50 to 300 mL/h; the carbonization temperature ranges from 200 to 1000° C.; and the carbonization has a temperature-rising rate of from 1 to 20° C./min.

The third object of the present invention is to provide a use of the heterogeneous metal-free Fenton catalyst for producing hydroxyl radicals to degrade pollutants.

The method for producing hydroxyl radicals comprises: reacting the carbon-based material modified with halogenated quinones with H₂O₂ solution.

The H₂O₂ solution has a concentration of from 0.1 to 100 mM, e.g. 0.2 mM, 0.5 mM, 1.5 mM, 1 mM, 5 mM, 10 mM, 15 mM, 35 mM, 50 mM, 75 mM or 95 mM, preferably from 5 to 50 mM, wherein said mM refers to mmol/L.

The reaction has a temperature of from 20 to 80° C., e.g. 25° C., 30° C., 35° C., 40° C., 45° C., 50° C., 55° C., 60° C., 70° C. or 75° C., preferably from 20 to 35° C.

The reaction has a pH of from 4 to 9, 4.5, 5, 6, 7, 8 or 8.5, preferably from 6 to 8.

The reaction goes on under stirring condition, wherein the stirring has a rate of from 50 to 300 r/min, e.g. 60 r/min, 80 r/min, 100 r/min, 150 r/min, 200 r/min, 250 r/min or 280 r/min, preferably from 100 to 120 r/min.

The reaction lasts for from 0.5 to 72 h, e.g. 1 h, 2 h, 5 h, 10 h, 12 h, 20 h, 22 h, 30 h, 35 h, 40 h, 45 h, 50 h, 60 h, 65 h or 70 h, preferably from 1 to 24 h.

The pollutant is any one selected from the group consisting of phenols, chlorobenzene, aniline or dyes, or a combination of at least two selected therefrom, wherein said phenols are, for example, chlorophenol, and the like. The typical but non-limiting pollutant combination is selected from the group consisting of phenols and chlorobenzene, chlorobenzene and aniline, phenols and dyes, phenols, aniline and chlorobenzene, chlorobenzene, aniline and dyes, phenols, chlorobenzene, aniline and dyes and the like.

The pollutant has a concentration of from 1 to 500 mg/L, e.g. 2 mg/L, 5 mg/L, 10 mg/L, 50 mg/L, 100 mg/L, 150 mg/L, 200 mg/L, 300 mg/L, 350 mg/L, 400 mg/L or 450 mg/L, preferably from 10 to 50 mg/L in water.

The pollutant has a concentration of from 1 to 200 mg/m³, e.g. 2 mg/m³, 5 mg/m³, 10 mg/m³, 20 mg/m³, 30 mg/m³, 50 mg/m³, 100 mg/m³, 120 mg/m³, 150 mg/m³ or 180 mg/m³, preferably from 10 to 50 mg/m³ in gaseous phase.

The pollutant has a concentration of from 1 to 100 mg/g, e.g. 2 mg/g, 5 mg/g, 10 mg/g, 20 mg/g, 30 mg/g, 40 mg/g, 50 mg/g, 60 mg/g, 70 mg/g, 80 mg/g or 90 mg/g, preferably from 10 to 50 mg/g in soil.

As compared with the prior art, the present invention has the following beneficial effects.

The carbon-based material and halogenated quinones provided in the present invention have synergistic effect.

Due to peroxidase-like properties, the carbon-based material per se will have nucleophilic substitution reaction with H₂O₂, and the surface-bonded halogenated quinones further strengthen the electrophilicity of the carbon-based material to promote the decomposition of H₂O₂, so as to directly produce hydroxyl radicals without dependence on transition metal ions.

The method for producing the heterogeneous metal-free Fenton catalyst provided in the present invention has a low cost and a safe, simple and convenient process. The conditions for producing hydroxyl radicals are mild, without any illumination, radiation, high temperature heating, or secondary pollution. The radicals have a high, continuous and stable yield, and the yield achieves 52% after 24 h of the reaction.

The heterogeneous metal-free Fenton catalyst provided in the present invention can be effectively used for producing hydroxyl radicals without using any chemicals harmful to human bodies. There is no by-product, and there is no need to additionally add any substance which is difficult to separate.

The heterogeneous metal-free Fenton catalyst and the preparation method provided in the present invention have a wide application prospect in the fields of organic pollutant degradation and catalytic material.

### DESCRIPTION OF THE FIGURES

FIG. 1 shows an electron spin spectroscopy (ESR) of hydroxyl radicals detected in Example 1 of the present invention.

FIG. 2 shows a liquid chromatography (LC) peak quantitative radical yield change map of the hydroxyl radical capture product detected in Example 1 of the present invention.

### EMBODIMENTS

The technical solution of the present invention is further stated by the specific embodiments in combination with the drawings. The following examples are just simple examples of the present invention, but do not represent or limit the protection scope of the present invention. The protection scope of the present invention is based on the claims.

The hydroxyl radical yields in the following examples are calculated by the following method: capturing the hydroxyl radicals produced by the reaction system by the method of hydroxylation of salicylic acid, and giving the quantitative results of hydroxyl radicals by liquid chromatogram. A standard curve of the hydroxylated product of salicylic acid: 2,3-dihydroxy-benzoic acid, is obtained and the yields of the hydroxylated product of salicylic acid are quantitatively calculated by external standard method, so as to compare the yields of the hydroxyl radicals. The radical yields are calculated by the ratio of hydroxyl radical concentration and the concentration of hydrogen peroxide added therein.

### EXAMPLE 1

A method for producing hydroxyl radicals comprises the following steps:
(1) ultrasounding 1.5 mg/mL of graphite oxide solution in water for 1 h at a power of 50 W to form a homogeneous graphite oxide dispersion;
(2) adding dropwise tetrachlorobenzoquinone solution into the graphite oxide dispersion obtained in step (1), wherein tetrachlorobenzoquinone and graphite oxide have a concentration rate of 3:1, ultrasonic grafting for 1 h at a power of 50 W to obtain a graphene oxide dispersion surface-grafted with tetrachlorobenzoquinone;
(3) adding H₂O₂ solution into the graphene oxide dispersion surface-grafted with tetrachlorobenzoquinone obtained in step (2) to initiate the reaction, wherein H₂O₂ and halogenated quinone have a concentration ratio of 5:1, adjusting the pH of the system to be 7, stirring the system at 30° C. in a water bath at a rate of 100 r/min; and
(4) taking a part of filtered sample separately at the time when the reaction lasts for 2 h, 4 h, 6 h, 10 h and 24 h to carry out the ESR test and LC test.

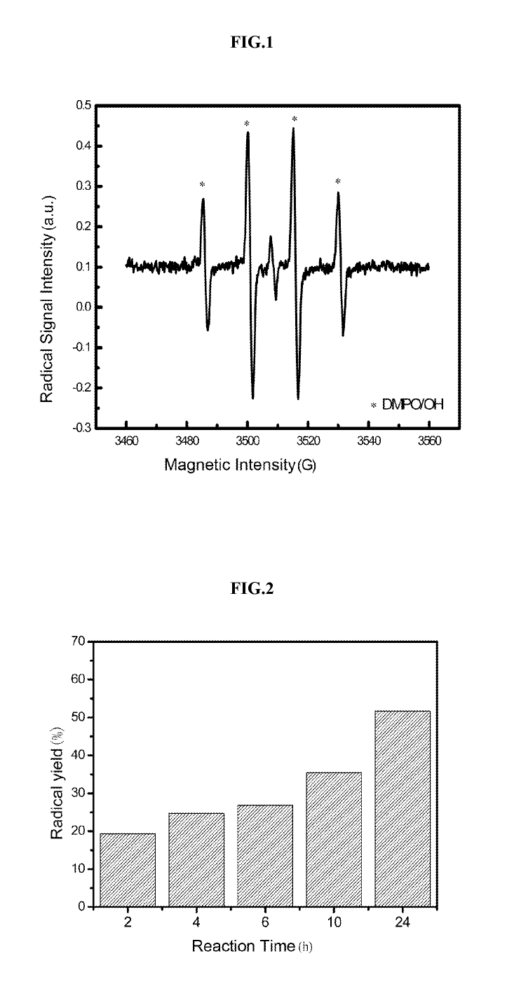

FIG. 1 shows an ESR of hydroxyl radicals detected and obtained; FIG. 2 shows an LC peak quantitative radical yield change map of the hydroxyl radical capture product detected.

According to the ESR scanning analysis and liquid chromatographic analysis, it can be seen that there produces hydroxyl radicals; there is a high signal strength and a high yield; the radical yield achieves 52% after 24 h of the reaction, and increases continuously.

### EXAMPLE 2

A method for producing hydroxyl radicals comprises the following steps:
(1) ultrasounding 2 mg/mL of graphite oxide solution in water for 1.5 h at a power of 50 W to form a homogeneous graphite oxide dispersion;
(2) adding dropwise tetrafluorobenzoquinone solution into the graphite oxide dispersion obtained in step (1), wherein tetrafluorobenzoquinone and graphite oxide have a concentration rate of 2:1, ultrasonic grafting for 1 h at a power of 80 W to obtain a graphene oxide dispersion surface-grafted with tetrafluorobenzoquinone;
(3) adding H₂O₂ solution into the graphene oxide dispersion surface-grafted with tetrafluorobenzoquinone obtained in step (2) to initiate the reaction, wherein H₂O₂ and tetrafluorobenzoquinone have a concentration ratio of 2.5:1, adjusting the pH of the system to be 7.4, stirring the system at 25° C. for 2 h in a water bath at a rate of 100 r/min; and
(4) taking the filtered sample with filter membrane separately at the time when the reaction lasts for 0.5 h, 1 h and 2 h to carry out the fluorescence spectrum test.

According to the fluorescence spectrum test, it can be seen that the product has an obvious emission spectrum peak at 435 nm under an excitation wavelength of 315 nm, which shows that the hydroxyl radicals have a high signal strength, a high yield; the radical yield achieves 48% after 24 h of the reaction, and increases continuously.

### EXAMPLE 3

A method for producing hydroxyl radicals comprises the following steps:
(1) ultrasounding 3 mg/mL of activated carbon solution in water for 2 h at a power of 80 W to form a homogeneous activated carbon dispersion;
(2) adding dropwise 2,5-dichlorobenzoquinone solution into the activated carbon dispersion obtained in step (1), wherein 2,5-dichlorobenzoquinone and activated carbon have a concentration rate of 3:1, ultrasonic grafting for 1 h at a power of 60 W to obtain an activated carbon dispersion surface-grafted with 2,5-dichlorobenzoquinone;
(3) adding H₂O₂ solution into the activated carbon dispersion surface-grafted with 2,5-dichlorobenzoquinone obtained in step (2) to initiate the reaction, wherein H₂O₂ and 2,5-dichlorobenzoquinone have a concentration ratio of 2:1, adjusting the pH of the system to be 6.8, stirring the system at 25° C. in a water bath at a rate of 100 r/min; and
(4) taking a part of the filtered sample in step (3) with a filter membrane at the time when the reaction lasts for 1 h, 3 h and 5 h to carry out the radical ESR test.

According to the ESR scanning analysis, it can be seen that the hydroxyl radicals obtained therein have a high signal strength and a high yield; the ESR signal diagram in this Example is similar to that in Example 1.

### EXAMPLE 4

A method for producing hydroxyl radicals comprises the following steps:
(1) ultrasounding 0.001 mg/mL of a solution of activated carbon and graphene in water for 24 h at a power of 50 W to form a homogeneous dispersion of activated carbon and graphene;
(2) adding dropwise 2,5-dichlorobenzoquinone solution into the dispersion of activated carbon and graphene obtained in step (1), wherein 2,5-dichlorobenzoquinone and graphene and activated carbon have a concentration rate of 0.1:1, ultrasonic grafting for 48 h at a power of 50 W to obtain a dispersion of activated carbon and graphene surface-grafted with 2,5-dichlorobenzoquinone;
(3) adding H₂O₂ solution into the dispersion of activated carbon and graphene surface-grafted with 2,5-dichlorobenzoquinone obtained in step (2) to initiate the reaction, wherein H₂O₂ and 2,5-dichlorobenzoquinone have a concentration ratio of 2:1, adjusting the pH of the system to be 4.0, stirring the system at 20° C. in a water bath at a rate of 50 r/min; and
(4) taking a part of the filtered sample in step (3) with a filter membrane at the time when the reaction lasts for 1 h, 3 h and 5 h to carry out the radical ESR test.

According to the ESR scanning analysis, it can be seen that the hydroxyl radicals obtained therein have a high signal strength and a high yield; the ESR signal diagram in this Example is similar to that in Example 1.

### EXAMPLE 5

A method for producing hydroxyl radicals comprises the following steps:
(1) ultrasounding 10 mg/mL of carbon black solution in water for 0.5 h at a power of 200 W to form a homogeneous carbon black dispersion;
(2) adding dropwise 2,5-dichlorobenzoquinone solution into the carbon black dispersion obtained in step (1), wherein 2,5-dichlorobenzoquinone and carbon black have a concentration rate of 30:1, ultrasonic grafting for 0.5 h at a power of 200 W to obtain a carbon black dispersion surface-grafted with 2,5-dichlorobenzoquinone;
(3) adding H₂O₂ solution into the carbon black dispersion surface-grafted with 2,5-dichlorobenzoquinone obtained in step (2) to initiate the reaction, wherein H₂O₂ and 2,5-dichlorobenzoquinone have a concentration ratio of 2:1, adjusting the pH of the system to be 9.0, stirring the system at 80° C. in a water bath at a rate of 300 r/min; and
(4) taking a part of the filtered sample in step (3) with a filter membrane at the time when the reaction lasts for 0.5 h, 3 h and 5 h to carry out the radical ESR test.

According to the ESR scanning analysis, it can be seen that the hydroxyl radicals obtained therein have a high signal strength and a high yield; the ESR signal diagram in this Example is similar to that in Example 1.

### EXAMPLE 6

A method for producing hydroxyl radicals comprises the following steps:
(1) ultrasounding 1.5 mg/mL of carbon nanotube solution in water for 2 h at a power of 50 W to form a homogeneous carbon nanotube dispersion;
(2) adding dropwise 2,3,5-trichloro-1,4-benzoquinone solution into the carbon nanotube dispersion obtained in step (1), wherein 2,3,5-trichloro-1,4-benzoquinone and carbon nanotube have a concentration rate of 2:1, water-bath stirring adsorption grafting for 3 h at a temperature of 30° C. to obtain a carbon nanotube dispersion surface-grafted with 2,3,5-trichloro-1,4-benzoquinone;
(3) adding H₂O₂ solution into the carbon nanotube dispersion surface-grafted with 2,3,5-trichloro-1,4-benzoquinone obtained in step (2) to initiate the reaction, wherein H₂O₂ and 2,3,5-trichloro-1,4-benzoquinone have a concentration ratio of 5:1, adjusting the pH of the system to be 7.0, stirring the system at 20° C. in a water bath at a rate of 110 r/min; and
(4) taking a part of the filtered sample with a filter membrane at the time when the reaction lasts for 2 h, 4 h, 6 h, 10 h and 24 h to carry out the LC test.

According to the LC test, it can be seen that the hydroxyl radicals obtained in step (4) have a high signal strength; the LC test results in this Example are similar to those in FIG. 2 of Example 1; the radical yield reaches 50% after 24 h of the reaction, and the yield continues to increase.

### EXAMPLE 7

A method for producing hydroxyl radicals comprises the following steps:
(1) ultrasounding 1.5 mg/mL of carbon nanotube solution in water for 2 h at a power of 50 W to form a homogeneous carbon nanotube dispersion;
(2) adding dropwise 2,3,5-trichloro-1,4-benzoquinone solution into the carbon nanotube dispersion obtained in step (1), wherein 2,3,5-trichloro-1,4-benzoquinone and carbon nanotube have a concentration rate of 10:1, water-bath stirring adsorption grafting for 48 h at a temperature of 25° C. to obtain a carbon nanotube dispersion surface-grafted with 2,3,5-trichloro-1,4-benzoquinone;
(3) adding H₂O₂ solution into the carbon nanotube dispersion surface-grafted with 2,3,5-trichloro-1,4-benzoquinone obtained in step (2) to initiate the reaction, wherein H₂O₂ and 2,3,5-trichloro-1,4-benzoquinone have a concentration ratio of 5:1, adjusting the pH of the system to be 7.0, stirring the system at 35° C. in a water bath at a rate of 210 r/min; and
(4) taking a part of the filtered sample with a filter membrane at the time when the reaction lasts for 2 h, 4 h, 6 h, 10 h and 24 h to carry out the LC test.

According to the LC test, it can be seen that the hydroxyl radicals obtained in step (4) have a high signal strength; the LC test results in this Example are similar to those in FIG. 2 of Example 1; the radical yield reaches 50% after 24 h of the reaction, and the yield continues to increase.

### EXAMPLE 8

A method for producing hydroxyl radicals comprises the following steps:
(1) ultrasounding 5.0 mg/mL of carbon nanotube solution in water for 5 h at a power of 80 W to form a homogeneous carbon nanotube dispersion;
(2) adding dropwise 2,3,5-trichloro-1,4-benzoquinone solution into the carbon nanotube dispersion obtained in step (1), wherein 2,3,5-trichloro-1,4-benzoquinone and carbon nanotube have a concentration rate of 10:1, water-bath stirring adsorption grafting for 2 h at a temperature of 50° C. to obtain a carbon nanotube dispersion surface-grafted with 2,3,5-trichloro-1,4-benzoquinone;
(3) adding H₂O₂ solution into the carbon nanotube dispersion surface-grafted with 2,3,5-trichloro-1,4-benzoquinone obtained in step (2) to initiate the reaction, wherein H₂O₂ and 2,3,5-trichloro-1,4-benzoquinone have a concentration ratio of 5:1, adjusting the pH of the system to be 8, stirring the system at 25° C. in a water bath at a rate of 150 r/min; and
(4) taking a part of the filtered sample with a filter membrane at the time when the reaction lasts for 2 h, 4 h, 6 h, 10 h and 24 h to carry out the LC test.

According to the LC test, it can be seen that the hydroxyl radicals obtained in step (4) have a high signal strength; the LC test results in this Example are similar to those in FIG. 2 of Example 1; the radical yield reaches 51% after 24 h of the reaction, and the yield continues to increase.

### EXAMPLE 9

A method for producing hydroxyl radicals comprises the following steps:
(1) ultrasounding 1 mg/mL of activated carbon solution in water for 1.5 h at a power of 60 W to form a homogeneous activated carbon dispersion;
(2) adding dropwise tetrabromobenzoquinone solution into the activated carbon dispersion obtained in step (1), wherein tetrabromobenzoquinone and activated carbon have a concentration rate of 2.5:1, heating reflux grafting for 5 h at a temperature of 70° C. to obtain an activated carbon dispersion surface-grafted with tetrabromobenzoquinone;
(3) adding H₂O₂ solution into the activated carbon dispersion surface-grafted with tetrabromobenzoquinone obtained in step (2) to initiate the reaction, wherein H₂O₂ and tetrabromobenzoquinone have a concentration ratio of 7:1, adjusting the pH of the system to be 7.5, stirring the system at 25° C. in a water bath at a rate of 100 r/min; and
(4) adding the pollutant chlorophenol solution into the metal-free Fenton reaction system to make the concentration thereof in the system be 50 mg/L, taking a part of the filtered sample to carry out the radical ESR test.

According to the ESR scanning analysis, it can be seen that the hydroxyl radicals obtained therein have a high signal strength and a high yield; the ESR signal diagram in this Example is similar to that in Example 1.

It can be seen by testing the concentration of chlorophenol that the degradation rate of chlorophenol after 24 h of the reaction reaches more than 90%.

### EXAMPLE 10

A method for producing hydroxyl radicals comprises the following steps:
(1) ultrasounding 3.0 mg/mL of activated carbon solution in water for 5 h at a power of 80 W to form a homogeneous activated carbon dispersion;
(2) adding dropwise tetrabromobenzoquinone solution into the activated carbon dispersion obtained in step (1), wherein tetrabromobenzoquinone and activated carbon have a concentration rate of 0.5:1, heating reflux grafting for 2 h at a temperature of 200° C. to obtain an activated carbon dispersion surface-grafted with tetrabromobenzoquinone;
(3) adding H₂O₂ solution into the activated carbon dispersion surface-grafted with tetrabromobenzoquinone obtained in step (2) to initiate the reaction, wherein H₂O₂ and tetrabromobenzoquinone have a concentration ratio of 7:1, adjusting the pH of the system to be 7.5, stirring the system at 30° C. in a water bath at a rate of 100 r/min; and
(4) adding the pollutant chlorophenol solution into the metal-free Fenton reaction system to make the concentration thereof in the system be 50 mg/L, taking a part of the filtered sample to carry out the radical ESR test.

According to the ESR scanning analysis, it can be seen that the hydroxyl radicals obtained therein have a high signal strength and a high yield; the ESR signal diagram in this Example is similar to that in Example 1.

It can be seen by testing the concentration of chlorophenol that the degradation rate of chlorophenol after 24 h of the reaction reaches more than 90%.

### EXAMPLE 11

A method for producing hydroxyl radicals comprises the following steps:
(1) ultrasounding 0.2 mg/mL of activated carbon solution in water for 5 h at a power of 50 W to form a homogeneous activated carbon dispersion;
(2) adding dropwise tetrabromobenzoquinone solution into the activated carbon dispersion obtained in step (1), wherein tetrabromobenzoquinone and activated carbon have a concentration rate of 20:1, heating reflux grafting for 24 h at a temperature of 50° C. to obtain an activated carbon dispersion surface-grafted with tetrabromobenzoquinone;
(3) adding H₂O₂ solution into the activated carbon dispersion surface-grafted with tetrabromobenzoquinone obtained in step (2) to initiate the reaction, wherein H₂O₂ and tetrabromobenzoquinone have a concentration ratio of 7:1, adjusting the pH of the system to be 8.5, stirring the system at 30° C. in a water bath at a rate of 150 r/min; and
(4) adding the pollutant chlorophenol solution into the metal-free Fenton reaction system to make the concentration thereof in the system be 50 mg/L, taking a part of filtered sample to carry out the radical ESR test.

According to the ESR scanning analysis, it can be seen that the hydroxyl radicals obtained therein have a high signal strength and a high yield; the ESR signal diagram in this Example is similar to that in Example 1.

It can be seen by testing the concentration of chlorophenol that the degradation rate of chlorophenol after 24 h of the reaction reaches more than 90%.

### EXAMPLE 12

A method for producing hydroxyl radicals comprises the following steps:
(1) carbonizing 2 mg of graphene material in a heating furnace, wherein the temperature rises at a rate of 10° C./min, and the carbonization temperature is 500° C.; feeding chlorine at a flow rate of 100 mL/h at the same time for oxidation, wherein the graphene and chlorine have a concentration ratio of 5:1, to obtain a composite material;
(2) adding the composite material into H₂O₂ solution, wherein H₂O₂ and chlorine have a concentration ratio of 8:1, adjusting the pH of the system to be 7, stirring the system at 25° C. in a water bath at a rate of 110 r/min; and
(3) taking a part of the filtered sample with a filter membrane at the time when the reaction lasts for 0.5 h, 1 h and 2 h to carry out the radical ESR test.

According to the ESR scanning analysis, it can be seen that the hydroxyl radicals obtained therein have a high signal strength and a high yield; the ESR signal diagram in this Example is similar to that in Example 1.

### EXAMPLE 13

A method for producing hydroxyl radicals comprises the following steps:
(1) carbonizing 3 mg of graphite oxide material in a heating furnace, wherein the temperature rises at a rate of 1° C./min, and the carbonization temperature is 200° C.; feeding chlorine at a flow rate of 50 mL/h at the same time for oxidation, wherein the graphite oxide and chlorine have a concentration ratio of 1:10, to obtain a composite material;
(2) adding the composite material into H₂O₂ solution, wherein H₂O₂ and chlorine have a concentration ratio of 8:1, adjusting the pH of the system to be 7, stirring the system at 25° C. in a water bath at a rate of 110 r/min; and
(3) taking a part of the filtered sample with a filter membrane at the time when the reaction lasts for 0.5 h, 1 h and 2 h to carry out the radical ESR test.

According to the ESR scanning analysis, it can be seen that the hydroxyl radicals obtained therein have a high signal strength and a high yield; the ESR signal diagram in this Example is similar to that in Example 1.

### EXAMPLE 14

A method for producing hydroxyl radicals comprises the following steps:
(1) carbonizing 8 mg of a mixture of carbon black and carbon nanotube in a heating furnace, wherein the temperature rises at a rate of 20° C./min, and the carbonization temperature is 1000° C.; feeding chlorine at a flow rate of 300 mL/h at the same time for oxidation, wherein the mixture of carbon black and carbon nanotube and chlorine have a concentration of 50:1, to obtain a composite material;
(2) adding the composite material into H₂O₂ solution, wherein H₂O₂ and chlorine have a concentration ratio of 8:1, adjusting the pH of the system to be 7, stirring the system at 25° C. in a water bath at a rate of 110 r/min; and
(3) taking a part of the filtered sample with a filter membrane at the time when the reaction lasts for 0.5 h, 1 h and 2 h to carry out the radical ESR test.

According to the ESR scanning analysis, it can be seen that the hydroxyl radicals obtained therein have a high signal strength and a high yield; the ESR signal diagram in this Example is similar to that in Example 1.

### COMPARISON EXAMPLE 1

A method for producing hydroxyl radicals comprises the same steps as Example 1, excluding step (2).

According to the ESR scanning analysis and liquid chromatographic analysis, it can be seen that the hydroxyl radicals obtained therein have a weak signal strength; the yield thereof is low and merely continues to increase during the early stage of the reaction; after 2 h of the reaction, the radical yield reaches a maximum of 20%.

### COMPARISON EXAMPLE 2

A method for producing hydroxyl radicals comprises the same steps as Example 1, except of using no graphite oxide solution.

According to the ESR scanning analysis and liquid chromatographic analysis, it can be seen that the hydroxyl radicals obtained therein have a weak signal strength; the yield thereof is low and merely continues to increase during the early stage of the reaction; after 3 h of the reaction, the radical yield reaches a maximum of 25%.

### COMPARISON EXAMPLE 3

A method for producing hydroxyl radicals comprises the same steps as Example 1, except of carrying out no ultrasounding in step (2).

According to the ESR scanning analysis and liquid chromatographic analysis, it can be seen that the hydroxyl radicals obtained therein have a weak signal strength; the yield thereof is low and merely continues to increase during the early stage of the reaction; after 2.5 h of the reaction, the radical yield reaches a maximum of 30%.

The aforesaid examples are only specific embodiments of the present invention, but the present invention is not limited by them. Those skilled in the art shall know that, any change or replacement which can be readily conceived within the technical scope disclosed in the present invention all fall within the protection scope and disclosure scope of the present invention.

1. A heterogeneous metal-free Fenton catalyst, wherein the catalyst is a carbon-based material surface-bonded with halogenated quinones.

2. The catalyst according to claim 1, wherein the halogenated quinones and the carbon-based material have a mass ratio of from 0.1 to 30.

3. The catalyst according to claim 1, wherein the carbon-based material is any one selected from the group consisting of graphite oxide, graphene, carbon nanotube, activated carbon, carbon fiber, carbon black and high-temperature carbonized natural organics, or a combination of at least two selected therefrom;
the halogenated quinones are any one selected from the group consisting of monochloroquinone, dichlorobenzoquinone, trichlorobenzoquinone, tetrachlorobenzoquinone, monobromoquinone, dibromobenzoquinone, tribromobenzoquinone, tetrabromobenzoquinone, or tetrafluorobenzoquinone, or a combination of at least two selected therefrom.

4. A method for preparing the catalyst according to claim 1, wherein the method comprises: mixing halogenated quinone solution with carbon-based material dispersion, surface-modifying the carbon-based material by halogenated quinone grafting method, to obtain a carbon-based material surface-bonded with halogenated quinones, or feeding chlorine during the carbonization of carbon-based material for oxidization, modifying carbon-based material by chlorine oxidation method to obtain a carbon-based material surface-bonded with halogenated quinones.

5. The method according to claim 4, wherein the carbon-based material is any one selected from the group consisting of graphite oxide, graphene, carbon nanotube, activated carbon, carbon fiber, carbon black or high-temperature carbonized natural organics, or a combination of at least two selected therefrom;
the carbon-based material in the carbon-based material dispersion has a concentration of from 0.001 to 10 mg/mL.

6. The method according to claim 4, wherein the carbon-based material dispersion is prepared by dispersing the carbon-based material into a solvent;
the solvent is water;
the dispersion is ultrasonic dispersion;
the ultrasonic power ranges from 50 to 200 W; and
the ultrasonic lasts for from 0.5 to 24 h.

7. The method according to claim 4, wherein the halogenated quinones in the halogenated quinone solution are any one selected from the group consisting of monochloroquinone, dichlorobenzoquinone, trichlorobenzoquinone, tetrachlorobenzoquinone, monobromoquinone, dibromobenzoquinone, tribromobenzoquinone, tetrabromobenzoquinone, or tetrafluorobenzoquinone, or a combination of at least two selected therefrom.

8. The method according to claim 4, wherein the halogenated quinone solution and the carbon-based material dispersion have a mass concentration ratio of from 0.1 to 30; and
the halogenated quinone solution is added dropwise into the carbon-based material dispersion.

9. The method according to claim 4, wherein the halogenated quinone grafting is any one selected from the group consisting of ultrasonic grafting, water-bath stirring adsorption grafting or heating reflux grafting, or a combination of at least two selected therefrom.

10. The method according to claim 9, wherein the ultrasonic grafting lasts for from 0.5 to 48 h;
the ultrasonic power ranges from 50 to 200 W.

11. The method according to claim 9, wherein the water-bath stirring adsorption grafting lasts for from 2 to 48 h; and
the water-bath stirring adsorption grafting is carried out at a temperature of from 25 to 50° C.

12. The method according to claim 9, wherein the heating reflux grafting lasts for from 2 to 24 h; and
the heating reflux grafting is carried out at a temperature of from 50 to 200° C.

13. The method according to claim 4, wherein in the chlorine oxidation, the carbon-based material and chlorine have a mass concentration ratio of from 0.1 to 50;
the chlorine has a flow of from 50 to 300 mL/h.

14. The method according to claim 4, wherein in the chlorine oxidation, the carbonization temperature ranges from 200 to 1000° C.; and
the carbonization has a temperature-rising rate of from 1 to 20° C./min.

15. The method according to claim 4, comprising:
ultrasonic-dispersing a carbon-based material in a solvent, the ultrasonic power ranges from 50 to 200 W; the ultrasonic lasts for from 0.5 to 24 h, to obtain a carbon-based material dispersion having a concentration of from 0.001 to 10 mg/mL; mixing halogenated quinone solution with the carbon-based material dispersion, wherein the halogenated quinone solution and the carbon-based material dispersion have a mass concentration ratio of from 0.1 to 30, to obtain a carbon-based material surface-bonded with halogenated quinones by halogenated quinone grafting method; or
feeding chlorine during the carbonization of the carbon-based material for oxidization; preparing a carbon-based material surface-bonded with halogenated quinones by chlorine oxidation, wherein the carbon-based material and chlorine have a mass concentration ratio of from 0.1 to 50; the chlorine has a flow of from 50 to 300 mL/h; the carbonization temperature ranges from 200 to 1000° C.; the carbonization has a temperature-rising rate of from 1 to 20° C./min.

16. A method of using the catalyst according to claim 1 for producing hydroxyl radicals to degrade pollutants.

17. The use method according to claim 16, wherein the method for producing hydroxyl radicals comprises: reacting a carbon-based material surface-bonded with halogenated quinones with H₂O₂ solution; and
the H₂O₂ solution has a concentration of from 0.1 to 100 mM.

18. The method according to claim 17, wherein the reaction has a temperature of from 20 to 80° C.;
the reaction has a pH of from 4 to 9;
the reaction goes on under stirring condition, wherein the stirring has a rate of from 50 to 300 r/min; and
the reaction lasts for from 0.5 to 72 h.

19. The method according to claim 16, wherein the pollutant is any one selected from the group consisting of phenols, chlorobenzene, aniline or dyes, or a combination of at least two selected therefrom.

20. The method according to claim 16, wherein the pollutant has a concentration of from 1 to 500 mg/L in water;
the pollutant has a concentration of from 1-200 mg/m³ in gaseous phase; and
the pollutant has a concentration of from 1 to 100 mg/g in soil.
